(19) United States
(12) Patent Application Publication
(10) Pub. No.: US 2003/0053162 A1
(43) Pub. Date: Mar. 20, 2003

(54) Method and apparatus for producing holographic stereograms

(76) Inventors: Michael Page, Toronto (CA); Thomas L. Haslett, Toronto (CA); David Demmer, Toronto (CA)

Correspondence Address: DOWELL & DOWELL PC, SUITE 309, 1215 JEFFERSON DAVIS HIGHWAY, ARLINGTON, VA, 22202

(21) Appl. No.: 10/189,141

(22) Filed: Jul. 5, 2002

Related U.S. Application Data
(60) Provisional application No. 60/303,822, filed on Jul. 10, 2001.

(51) Int. Cl. G03H 1/04

(52) U.S. Cl. 359/35; 430/1

(57) ABSTRACT

The present invention provides a method and apparatus for producing holographic stereograms. Holographic stereograms have made possible the creation of holograms of both real objects in natural or studio lighting and virtual objects created using three-dimensional graphics. There are several approaches for creating holograms from digital graphics. This paper discusses the application of the light valve to the process along with other related developments. Artists can now produce high quality inexpensive, medium-format holograms using this direct-link to digital media. Future developments will led to even higher resolution Digital Image-Light-Amplifier (D-ILA) systems.

### CROSS REFERENCE TO RELATED UNITED STATES PATENT APPLICATION

This patent application relates to U.S. provisional patent application Ser. No. 60/303,822 filed on Jul. 10, 2001, ENTITLED THE APPLICATION OF THE LIGHT VALVE TO HOLOGRAPHIC STEREOGRAMS.

### FIELD OF THE INVENTION

The present invention relates to a method and device for producing holographic stereograms.

### BACKGROUND OF THE INVENTION

Liquid crystal display (LCD) panels are often used in the production of holographic stereograms, however the size, resolution, contrast ratio, and insertion losses of this technique create serious limitations for holographers and stereograms produced this way contain the familiar “fish-scale” patina. Motion picture film is used to produce larger images in greater detail, however, registration is often a problem and film-recording costs have largely limited production. Full color work requires the additional expense of producing color separated film footage. Few holographers are able to afford the production costs associated with medium and large format stereograms. This direct digital link between a variety of 3D digital imaging processes and holography represents a significant improvement to the holographic process.

U.S. Pat. No. 5,560,17 discloses direct holographic recording which eliminates many troublesome aspects of conventional holography. The process relies on known ray-tracing algorithms to predict the pattern of light that would be present on the holographic recording material when making a conventional hologram of the object and prints the calculated pattern directly on the recording material. Images are then tiled to form large mural-sized holographic scenes. The technique is enormously computationally intense. Holographic pixels that make up the scene are often too large to be understood well at close viewing distances. The cost of each custom made panel is prohibitive for most users. Mural-sized holograms also have extremely limited application because of strict illumination requirements. The current capital costs to implement this technology are over 10 million dollars.

It would be very advantageous to provide an economic method and apparatus for producing holographic stereograms that avoids the expense of present commercial systems.

### SUMMARY OF THE INVENTION

The present invention provides a method of producing holographic stereograms, comprising:

a) focusing an image of an object onto an image light amplifier means which encodes said image in a birefringent material in said image light amplifier means;

b) directing a beam of coherent polarized light first through said birefringement material such that the polarization of said beam of polarized light is spatially varied in a manner that reflects the image encoded in the birefringement material and then through a polarizer to produce a coherent polarized beam of light that is spatially imprinted with said image;

c) focusing said coherent polarized beam of light that is spatially imprinted with said image onto a light diffusing means; and

d) capturing coherent polarized light scattered from the light diffusing medium on a holographic recording medium and focusing a reference beam of coherent polarized light on said holographic film which interferes with said coherent polarized light scattered from the light diffusing means light to holographically record said image.

In another aspect of the present invention there is provided an apparatus for producing holographic stereograms, comprising:

a) image light amplifier means having a back surface onto which an image is projected and containing a birefringement material, said image light amplifier means including encoding means for encoding an image in said birefringent material that has been projected onto said surface;

b) a light source and means for polarizing and directing a light beam into said birefringent material through a transparent front surface of said image light amplifier, reflection means for reflecting said light beam back through said birefringent material and out through the transparent front surface to produce a coherent polarized beam that is spatially imprinted with said image;

c) means for polarizing and focusing said coherent polarized beam that is spatially imprinted with said image onto a means for diffusing light which produces scattered coherent polarized light;

d) a holographic recording medium positioned to capture said scattered coherent polarized light; and

e) means for producing and focusing a reference beam of coherent polarized light onto said holographic recording medium wherein said reference beam interferes with said scattered coherent polarized light to holographically record said image on said holographic recording medium.

In another aspect of the invention there is provided an apparatus for producing a coherent polarized beam that is spatially imprinted with an image, comprising:

a) image light amplifier means containing a birefringement material;

b) image projection means for projecting an image onto a back surface of said image light amplifier means and encoding means for encoding said image in said birefringent material; and

c) a light source and means for polarizing and directing a light beam into said birefringent material through a transparent front surface of said image light amplifier, reflection means for reflecting said light beam back through said birefringent material and out through the transparent front surface to produce a coherent polarized beam that is spatially imprinted with said image.

### BRIEF DESCRIPTION OF THE DRAWINGS

Preferred embodiments of the invention will now be described, by way of example only, with reference being had to the drawings, in which:

FIG. 1 shows a light valve stereogram printer apparatus constructed in accordance with the present invention for producing holographic stereograms;

FIG. 2 shows a block diagram of a light valve projector forming part of the apparatus of FIG. 1;

FIG. 3 is cross section of an image light amplifier forming part of the light valve projector of FIG. 2;

FIG. 4 shows a block diagram of an alternative embodiment of a light valve projector forming part of the apparatus of FIG. 1;

FIG. 5 is a cross section of a single pixel of a digital light amplifier forming part of the digital light valve projector of FIG. 4;

FIG. 6 illustrates an array of holographic elements for a full-color master transmission hologram; and

FIG. 7 illustrates an array of holographic elements for full-parallax, full-color reflection master holograms.

### DETAILED DESCRIPTION OF THE INVENTION

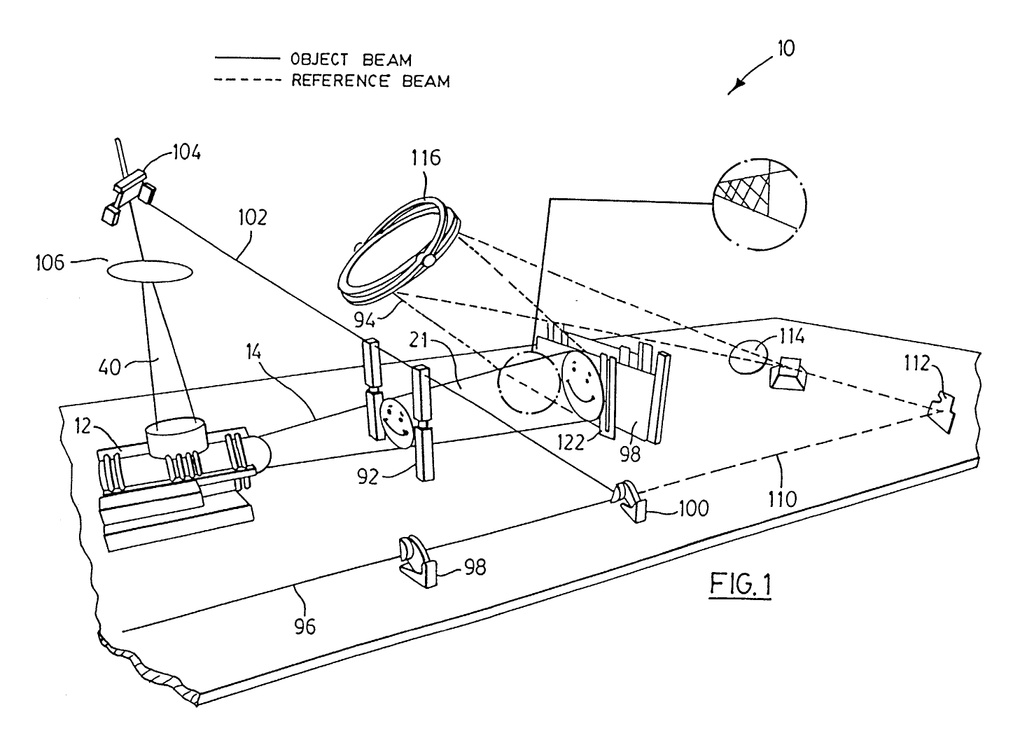

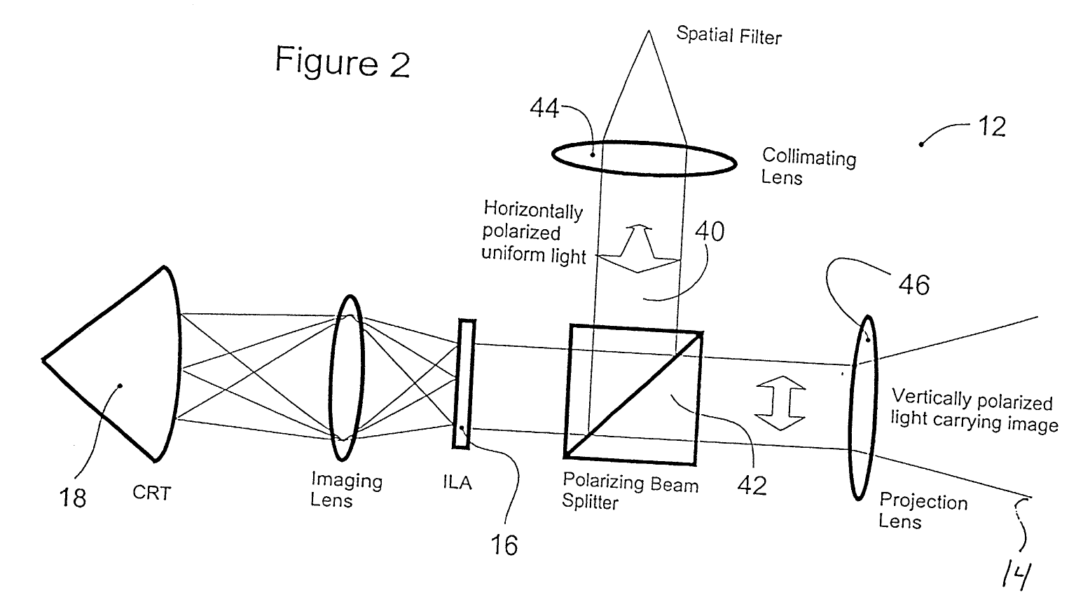

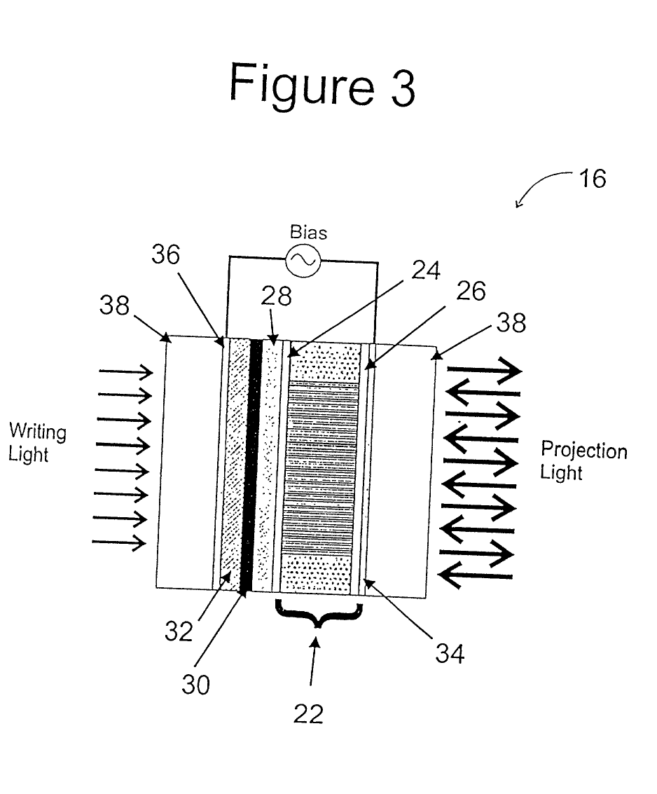

Referring to FIG. 1, a light valve stereogram printer apparatus constructed in accordance with the present invention is shown generally at 10. Apparatus 10 includes a light valve 12 for producing and projecting a polarized light beam 14 that is spatially imprinted with an image to be converted to a holographic stereogram. Referring to FIG. 2, the light valve projector 12 includes an Image Light Amplifier (ILA) 16 onto which an image from a high resolution cathode ray tube (CRT) 18 is focused. The image may be taken from a video source, or output from a computer. The image from the CRT 18 is projected onto the rear of the ILA 16. Referring to FIG. 3, the ILA 16 is a multi-layer device with a central layer 22 being comprised of liquid crystal sandwiched between liquid crystal alignment films 24 and 26. A dielectric mirror 28 is sandwiched between film 24 and a light blocking layer 30 and an amorphous photoconducting silicon layer 32 is located on light blocking layer 30. A transparent conducting electrode 36 is located on the back surface of silicon layer 32 and a bias is applied between electrode 36 and a transparent conducting counter electrode 34 located on the front face of alignment film 26. The entire assembly is sandwiched between glass plates 38.

The image on the rear face of the ILA 16 is picked up by amorphous silicon layer 32 after passing through conductive glass layer 36. The light striking the silicon layer 32 will induce photo-conductivity in that layer in proportion to the brightness of the light at that point. The result is that the image displayed on the CRT 18 is transferred, or encoded, into a matching resistance pattern in the amorphous silicon layer 32. The bias across the device then results in the same pattern of voltage across the liquid crystal 22 and the liquid crystal is aligned to varying degrees corresponding to the image intensity. The overall functioning of the device is then to convert the image into a pattern of liquid crystal alignment.

Referring again to FIGS. 2 and 3, the projection step occurs using polarized light and birefringence of the liquid crystal. The liquid crystal 22 (FIG. 3) is a birefringent material when it is aligned so that the index of refraction is different for light polarized in different directions. Polarized light passing through a birefringent material can undergo a change in polarization. Referring particularly to FIG. 2, the ILA 16 is then read-out by bringing in a polarized light beam 40 from for example a laser or arc lamp (not shown). The polarized beam 40 is directed to a polarizing beam splitter 42 which splits the beam so that one beam is directed towards the front surface of the ILA 16. Referring to FIG. 3, this beam passes through the liquid crystal layer 22, reflects from the dielectric mirror 28, and passes back through the liquid crystal 22 again. The polarization is then altered to varying degrees spatially as dictated by the alignment of the liquid crystal 22, which is in turn determined by the original image on the CRT 18 encoded in the photoconducting layer 32. Passing the returning beam through polarizer 42 (FIG. 2) then produces a polarized beam 14 that is spatially imprinted with the image which is then focused by a projection lens 46. The split light beam directed back through collimating lens 44 by the polarizer 42 contains the negative image. The light blocking layer 30 in ILA 16 (FIG. 3) prevents any leakage from the high intensity read-out light causing photo-conductivity in the silicon layer, which would reduce contrast.

The polarizing beam splitter 42 is the preferred device for separating the image from the returning beam due to the high efficiency and large aperture achievable. Although less desirable, other embodiments that would perform the same function are possible. One such configuration is a simple 50% beam splitter (for example a partially silvered mirror) with a polarizing film inserted in the projected beam. In this case, the efficiency would be very poor as half the incident light is rejected on the way in and half of the light of the correct polarization that is imprinted with the image is also unnecessarily rejected. It is also possible to configure the ILA such that the reflected light is not directly counter-propagating to the incident light. Then no beam splitter is required and only a polarizer is needed. In this case, the contrast is reduced, possibly significantly, since the off-normal reflection through the birefringent liquid crystal will result in less pure polarization encoding of the image information. Another possible device would involve another appropriately oriented birefringent material such as quartz or calcite. In these materials differently polarized light is refracted through different angles and the beams of each polarization are physically separated as they pass through the material. The big disadvantage to this technique would be the massive size of pure crystal that would be required to separate the beams, which would be prohibitively expensive and difficult to manufacture.

In the case of other types of ILA that encode information in intensity rather than polarization (for example the micromirror array described hereinafter) either a simple 50% beam splitter alone is required (again leading to high inefficiencies) or preferentially the off-axis reflection method could be employed without loss of contrast.

Referring again to FIG. 1, the coherent wavefront 14 projected from the ILA 16 is then projected onto to a diffusing medium, or diffuser 92, such as a ground glass plate or, preferably, a light shaping diffuser (LSD). The light scattered from the diffuser 92 is then holographically recorded. The light shaping diffusers are holographically recorded randomized surface structures that provide nearly 90% transmission. These devices can be considered as a superposition of numerous random gratings, having the effect of efficiently scattering light through a multitude of angles. By design, light-shaping diffusers can be made to have viewing angles ranging from a few to over a hundred degrees and can have different spreads in different directions. This provides holographers with dramatically increased control over the uniformity of illumination while still concentrating the light within an effective area. This results in a substantial saving of laser energy, which permits shorter exposure times. Furthermore, the light shaping diffusers do not rely on multiple scattering events, so there is no loss in coherence or polarization information. The overall result is considerably superior to results achieved using ground glass or similar diffusers.

Following projection from light valve 12 and scattering from the diffuser 92, the still coherent and still polarized scattered light (preferentially scattered in a cone 17 containing the holographic recording medium (e.g holographic film) for maximum efficiency) is interfered or mixed with a reference beam 94 that is coherent with the scattered beam 21 and of the same polarization, see FIG. 1. The reference beam 94 is from the same source as the beam 40 (FIGS. 1 and 2). A light source (not shown) produces a beam 96 which is focused by a lens 98 and upon hitting beam splitter 100, one of the beams 102 is reflected by mirror 104 and expanded through lens 106 to produce beam 40 which enters the light valve 12. The other beam 1 10 is directed by a mirror 1 12 to expanding lens 114 and a collimating mirror 116 directs the reference beam 94 to the holographic film 98. The holographic film 98 is placed in the plane where the beams 94 and 21 interfere and the interference pattern thus captured on film 98 is a holographic recording.

The holographic stereogram is a plurality of holograms of two-dimensional images. These images may come from 3D-computer animation software, video, motion picture film or multiple photographs taken from different views. They may also be obtained with image capture technology. Each two-dimensional scene is presented on the LSD light shaping diffuser and recorded as described below. To make a stereogram, a single image is projected onto the diffuser 92 and holographically recorded in a specific position on the film 98 by masking the film to expose only a vertical slit (or checkerboard pattern of exposures) using the translating aperture apparatus 122. A fresh image of the same object taken from a slightly different viewpoint is subsequently projected along with a simultaneous repositioning of the slit to capture the hologram of the new image in an appropriate place on the film. By repeating this procedure numerous times in this way, the stereogram is built up with a number of frames of the object as viewed from different positions. To record master holograms for monochromatic and achromatic (colorless) holograms, long, narrow slits such as seen in translating aperture apparatus 122 in FIG. 1 are used.

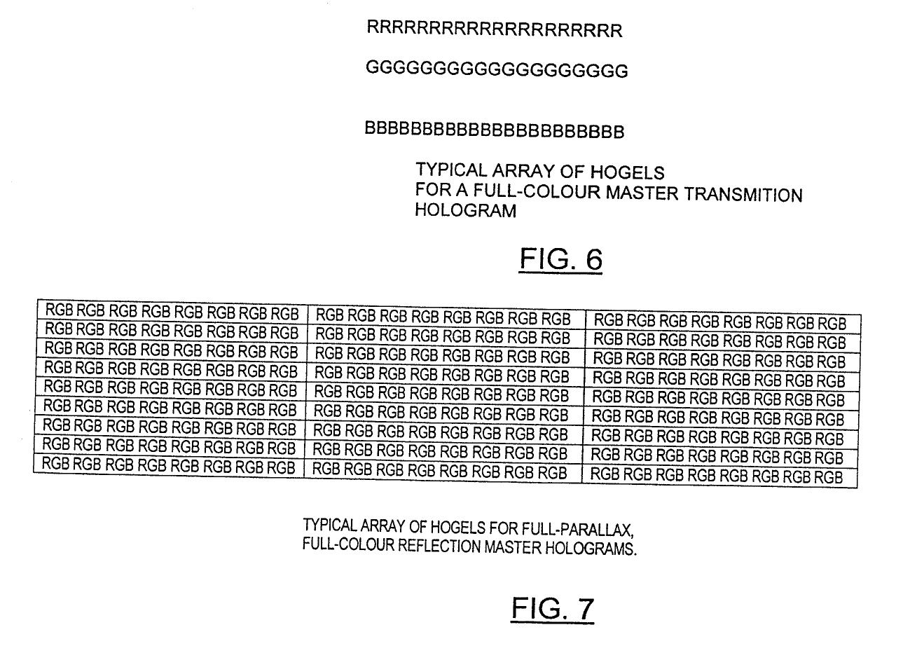

For master holograms, variations on this process include: the production of full-color transmisson holograms that form overlapping spectra from red, green and blue (RGB) strips of holographic pixels (hogels), see FIG. 6; production of full color, full parallax holograms (having both vertical and horizontal “look-around” views) reflection holograms from RGB hogels in a “corn row” array, see FIG. 7.

For transfer holograms in the full-color transmission model, rows of hogels form the look around view for each of the red, green and blue elements which are later combined to form the full color transfer hologram, see FIG. 6. In the full color, full parallax reflection master model, the hogels form an array much like conventional television. This master is then transferred using known color control techniques to form a full color transfer, see FIG. 7.

The light valve stereogram printer apparatus 10 disclosed herein eliminates the time, effort and expense of production from motion picture film. The near photographic resolution and extremely high contrast ratio produce detailed holograms. The smoothing effect introduced by the finite bandwidth of the CRT 18 (FIG. 2) reduces the evidence of pixels adding to the film-like appearance. Full color work is also made easy with almost immediate color separations and absolute registration from frame to frame.

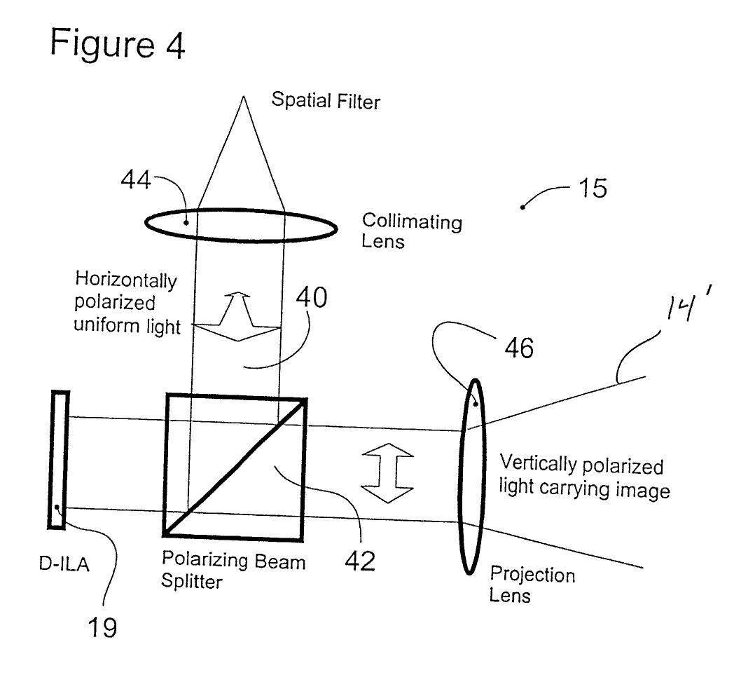

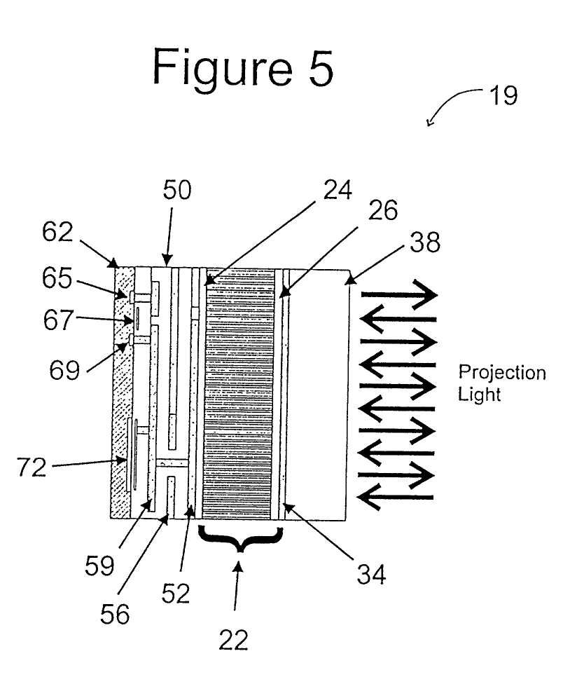

FIGS. 4 and 5 illustrate an alternative embodiment of an apparatus for producing holographic stereograms in which the analog image light amplifier has been replaced by a digital image light amplifier (D-ILA) as recently developed by Hughes/JVC Technologies that incorporates an ILA with newly developed liquid crystal technology, as disclosed in “D-ILA PROJECTOR TECHNOLOGY: The Path to High Resolution Projection Displays”, W. P. Bleha, JVC Digital Image Technology Center, 2310 Camino Vida Roble, Carlsbad, Calif. 92009. This has radically reduced the size of the high resolution digital projection systems.

Referring to FIG. 4, the digital light valve projector 15 includes a Digital Image Light Amplifier (DILA) 19 which directly receives image information in digital form from a computer or digital video source. Referring to FIG. 5, the DILA 19 is a multi-layer device with a central layer 22 being comprised of liquid crystal sandwiched between liquid crystal alignment films 24 and 26, as in the ILA device. The transparent electrode 34 and supporting glass layer 38 remain the same as in the ILA device 15 shown in FIG. 3. The layers on the opposite side of the central layer 22 have been replaced by an array of specialized transistors, each making up a single pixel as shown in FIG. 5. The transistor is built on a silicon substrate 62 and consists of a source electrode 65, a gate electrode 67, a drain electrode 69, and a capacitor 72. Above the electrodes is a silicon dioxide layer 50 in which are embedded three metal layers consisting of a wiring layer 59, a light blocking layer 56, and a reflective electrode layer 52. The digital signal for the pixel is first converted to an analog voltage using an analog-to-digital converter. The resulting voltage is then applied to a sample-and-hold amplifier where the analog voltage stored in this way is applied to the gate electrode 67 of the pixel. This voltage bias in turn controls the voltage of the drain electrode 69 which is connected through the wiring layer 59 to the reflective electrode 52. The voltage on the reflective electrode 52 acts to align the liquid crystal layer 22 to a degree proportional to the voltage of the reflective electrode 52. As well as aligning the liquid crystal, the reflective electrode 52 is also made highly reflective to act as a mirror. A small amount of the projection light incident on the reflective electrode layer 52 through the central layer 22 passes through or around the reflective electrode 52. In between the wiring layer 59 and the reflective electrode 52 is a light blocking layer 56 that prevents this light from reaching the wiring or substrate layers, an event which would induce an undesirable photocurrent and voltage change in the device, thus reducing contrast. While only a single pixel is illustrated in FIG. 5, it is clear that an array of pixels, each with an appropriate voltage applied to the gate electrode 67, will reproduce an image as a pattern of voltages on the reflective electrode layer 52. This voltage pattern will in turn produce a matching pattern in the degree of liquid crystal alignment in the central layer 22 corresponding to the original digital pattern applied to the array.

Referring to FIGS. 4 and 5, the projection step occurs as before using polarized light and birefringence of the liquid crystal. The liquid crystal 22 (FIG. 5) is a birefringent material when it is aligned so that the index of refraction is different for light polarized in different directions. Polarized light passing through a birefringent material can undergo a change in polarization. Referring particularly to FIG. 4, the DILA 19 is then read-out by bringing in a polarized light beam 40 from for example a laser or arc lamp (not shown). The polarized beam 40 is directed to a polarizing beam splitter 42 which splits the beam so that one beam is directed towards the front surface of the DILA 19. Referring to FIG. 5, this beam passes through the liquid crystal layer 22, reflects from the reflective electrode 52, and passes back through the liquid crystal 22 again. The polarization is then altered to varying degrees spatially as dictated by the alignment of the liquid crystal 22, which is in turn determined by the digital information encoded as a voltage on the gate electrode 67. Passing the returning beam through polarizer 42 (FIG. 2) then produces a polarized beam that is spatially imprinted with the image which is then focused by a projection lens 46. The split light beam directed back through collimating lens 44 by the polarizer 42 contains the negative image. The light blocking layer 56 in DILA 19 (FIG. 5) prevents any leakage from the high intensity read-out light causing photo-conductivity in the silicon or metal layers, which would reduce contrast.

The coherent wavefront projected from the DILA 19 (FIG. 5) is then holographically recorded as described above with respect to the embodiment using the ILA in FIGS. 1 to 3. The use of D-ILAs in the holographic apparatus disclosed herein is very advantageous as it eliminates many of the heat generating components, such as the CRT 18 (FIG. 2) and associated electronics, as well as the potentially dangerous high voltages required by the CRT 18.

It is noted that an alternate method of high brightness projection that is in principle available and suitable for holographic application is the Digital Light Processing projector. This device is based on an array of micromirrors where each micromirror represents a single pixel. In this case, the mirror has 2 positions: the “off” position in which the incident light is reflected away from the projection system and the “on” position in which the incident light is reflected into the projection system to be imaged as a pixel on the diffusing medium. Because the mirror is a binary device, gray scale is more difficult to implement and is achieved by rapidly moving the mirror between the on and off positions with the relative amount of time spent in each position determining the light level. The motion inherent to this method will necessarily introduce some degradation of the hologram, which may be anywhere from not significant to unusable.

Researchers in the field of biomedicine routinely utilize volumetric displays of data from CAT scans, MRI and con-focal microscopy for various applications including treatment planning of radiation therapy. Users can send images from hospital PAC (Picture Archive and Communications) systems via the Internet using utilities such as E-film to be printed as holograms.

Holographic stereograms have made possible the creation of holograms of both real objects in natural and studio lighting and virtual objects created using three-dimensional graphics. Holography represents a powerful visual medium for the presentation of volumetric imagery. By eliminating the extra step to motion picture film the light valve printer disclosed herein provides an inexpensive means of production of 3D hard copy for dimensional imaging. The use of D-ILAs mean ever increasing resolution SLMs for use in holographic applications. Medical researchers and physicians using volumetric displays advantageously benefit from an inexpensive, high resolution, direct recording system for auto-stereoscopic displays.

The method and apparatus disclosed herein for producing holographic stereograms based on the image light amplifier provides a direct link from digital graphics to holography. Its high resolution and contrast ratio makes it an excellent choice for small and medium format (50 cm×60 cm) holograms.

As used herein, the terms “comprises”, “comprising”, “includes” and “including” are to be construed as being inclusive and open ended, and not exclusive. Specifically, when used in this specification including claims, the terms “comprises” and “comprising” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. A method of producing a holographic stereogram, comprising:
a) focusing an image of an object onto an image light amplifier means which encodes said image in a birefringent material in said image light amplifier means;
b) directing a beam of polarized light first through said birefringement material such that the polarization of said beam of polarized light is spatially varied in a manner that reflects the image encoded in the birefringement material and then through a polarizer to produce a polarized beam of light that is spatially imprinted with said image;
c) focusing said coherent polarized beam that is spatially imprinted with said image onto a light diffusing means; and
d) capturing coherent polarized light scattered from the light diffusing medium on a holographic recording medium and focusing a reference beam of coherent polarized light on said holographic film which interferes with said coherent polarized light scattered from the light diffusing means light to holographically record said image.

2. The method according to claim 1 wherein steps a) to d) are performed after first masking the holographic recording medium except for a selected position and holographically recording said image in said selected position on said holographic recording medium,
e) masking the holographic recording medium except for a new selected position and projecting another image of the same object taken from a slightly different viewpoint and repeating steps a) to d) to holographically record the new image in said new selected position on the holographic recording medium,
f) repeating step e) a pre-selected number of times to build up a holographic stereogram with a number of frames of the object as viewed from different positions.

3. The method according to claim 1 wherein the light diffusing means is a light shaping diffuser.

4. The method according to claim 1 including projecting said image onto a surface of said image light amplifier means using an image projection means.

5. The method according to claim 1 wherein said image light amplifier means is an analog light image amplifier.

6. The method according to claim 4 wherein said image projection means is a cathode ray tube.

7. The method according to claim 1 wherein said image light amplifier means is a digital light image amplifier.

8. The method according to claim 2 wherein said image is a single color image, and wherein the step of masking said holographic recording medium is accomplished using a translating vertical slit apparatus.

9. The method according to claim 1 wherein said light source is a laser and said light beam is a coherent light beam.

10. The method according to claim 1 wherein said image is a multicolor image, and wherein individual holographic elements are created for each of the red, blue and green information and printed in such a way as to produce overlapping spectra.

11. The method according to claim 1 wherein said images originate from one of 3D-computer animation software, video, motion picture film, photographs of objects taken from different views and image capture means.

12. An apparatus for producing a holographic stereogram, comprising:
a) image light amplifier means having a back surface onto which an image is projected and containing a birefringement material, said image light amplifier means including encoding means for encoding an image in said birefringent material that has been projected onto said surface;
b) a light source and means for polarizing and directing a light beam into said birefringent material through a transparent front surface of said image light amplifier, reflection means for reflecting said light beam back through said birefringent material and out through the transparent front surface to produce a coherent polarized beam that is spatially imprinted with said image;
c) means for polarizing and focusing said coherent polarized beam that is spatially imprinted with said image onto a means for diffusing light which produces scattered coherent polarized light;
d) a holographic recording medium positioned to capture said scattered coherent polarized light; and
e) means for producing and focusing a reference beam of coherent polarized light onto said holographic recording medium wherein said reference beam interferes with said scattered coherent polarized light to holographically record said image on said holographic recording medium.

13. The apparatus according to claim 12 wherein the means for diffusing light is a light shaping diffuser.

14. The apparatus according to claim 12 including image projection means spaced from said back surface of said image light amplifier means for projecting an image onto said back surface.

15. The apparatus according to claim 12 wherein said image light amplifier means is an analog light image amplifier.

16. The apparatus according to claim 15 wherein said back surface of said image light amplifier means is a photoconductive layer, so that light from said image incident on said photoconductive layer induces photo-conductivity in said photoconductive layer in proportion to the brightness of the light at that point on the layer so that the image projected onto the photoconductive layer is encoded into a matching resistance pattern in the photoconductive layer, said image light amplifier means including means for applying a potential bias across said photoconductive layer and said liquid crystal which results in the same pattern of voltage across the liquid crystal as across the photoconductive to convert the image into a pattern of liquid crystal alignment.

17. The apparatus according to claim 15 wherein said image projected onto said analog light amplifier means is produced using a cathode ray tube.

18. The apparatus according to claims 12 wherein said image light amplifier means is a digital light image amplifier.

19. The apparatus according to claim 12 wherein said image is a single color image, including a translating aperture apparatus for masking said holographic recording medium and exposing a pre-selected area of said holographic recording medium.

20. The apparatus according to claim 19 wherein said translating aperture apparatus defines a vertical slit through which images are projected onto said holographic recording medium.

21. The apparatus according to claim 12 wherein said light source is a laser and said light beam is a coherent light beam.

22. The apparatus according to claim 12 wherein said image is a multicolor image, including a masking apparatus that exposes rectangular regions defining holographic pixels of the holographic recording medium.

23. The apparatus according to claim 12 wherein said means for polarizing and directing said light beam is a polarizing beam splitter located adjacent to said transparent front face of said image light amplifier.

24. The apparatus according to claim 12 wherein said holographic recording medium is holographic film.

25. An apparatus for producing a coherent polarized beam that is spatially imprinted with an image, comprising:
a) image light amplifier means containing a birefringement material;
b) image projection means for projecting an image onto a back surface of said image light amplifier means and encoding means for encoding said image in said birefringent material; and
c) a light source and means for polarizing and directing a light beam into said birefringent material through a transparent front surface of said image light amplifier, reflection means for reflecting said light beam back through said birefringent material and out through the transparent front surface to produce a coherent polarized beam that is spatially imprinted with said image.

26. The apparatus according to claim 25 wherein said image light amplifier means is a digital light image amplifier.

27. The apparatus according to claim 26 wherein said image light amplifier means is an analog light image amplifier wherein said back surface of said image light amplifier means is a photoconductive layer, so that light from said image incident on said photoconductive layer induces photo-conductivity in said photoconductive layer in proportion to the brightness of the light at that point on the layer so that the image projected onto the photoconductive layer is encoded into a matching resistance pattern in the photoconductive layer, said image light amplifier means including means for applying a potential bias across said photoconductive layer and said liquid crystal which results in the same pattern of voltage across the liquid crystal as across the photoconductive to convert the image into a pattern of liquid crystal alignment.
